(19) United States
(12) Patent Application Publication
(10) Pub. No.: US 2005/0183236 A1
(43) Pub. Date: Aug. 25, 2005

(54) Sliding replacement door

(76) Inventors: Donald P. Wichman, Raleigh, NC (US); Michael D. Morse, Valparaiso, FL (US); David J. Wagner, Lake Zurich, IL (US)

Correspondence Address: BURNS DOANE SWECKER & MATHIS L L P, POST OFFICE BOX 1404, ALEXANDRIA, VA, 22313-1404, US

(21) Appl. No.: 11/035,731

(22) Filed: Jan. 18, 2005

Related U.S. Application Data
(60) Provisional application No. 60/536,675, filed on Jan. 15, 2004.

(51) Int. Cl. E05D 15/00

(52) U.S. Cl. 16/91

(57) ABSTRACT

A sliding replacement door is made of an extendable covering and a mechanism for extending the covering into the doorway and retracting it therefrom. The extendable covering includes a pair of plastic or vinyl sheets on respective spring-biased rollers, analogous to a window shade. The free ends of the sheets are attached to a movable, vertically oriented bar. The rollers are spring-biased to cause the sheets to normally be wrapped around them, and thereby pull the bar towards them. The extension mechanism causes the bar to move horizontally in a direction away from the rollers, to thereby unroll the sheets from the rollers against the spring bias, and extend them into the door opening. The extension mechanism can be a motor-operated scissors mechanism.

This disclosure is based upon, and claims priority from, Provisional U.S. Patent Application No. 60/536,675, filed Jan. 15, 2004, the contents of which are incorporated herein by reference.

### BACKGROUND OF THE INVENTION

The present invention relates to a sliding, retractable door that can be used as a replacement for a standard solid door made of wood, metal or other suitable building material.

### BRIEF DESCRIPTION OF THE DRAWINGS

FIG. 1 is a perspective, overall view of the sliding replacement door in a retracted, open position;

FIG. 2 is a perspective view of the sliding replacement door in an extended, closed position;

FIG. 3 is a top view of the sliding replacement door mechanism in the open position;

FIG. 4 is a more detailed view of the mechanism for automatically closing and opening the sliding replacement door; and

FIG. 5 is a more detailed view of the relationship of the lead screw to the spring-loaded follower during door closing and opening operations.

### DETAILED DESCRIPTION

The sliding retractable door of the present invention can be employed as a replacement for a variety of different types of doors to seal off a room or other enclosure. For example, it can be used as a replacement for a standard residential interior door at the entrance to a room, entrance to a walk-in closet or the like. In a smaller version, it can be utilized as a replacement for a kitchen cabinet door. To facilitate an understanding of the invention, an embodiment thereof will first be described that can function as a replacement for a standard 32-inch wide door that is commonly found at the entranceways to rooms and closets in a residence.

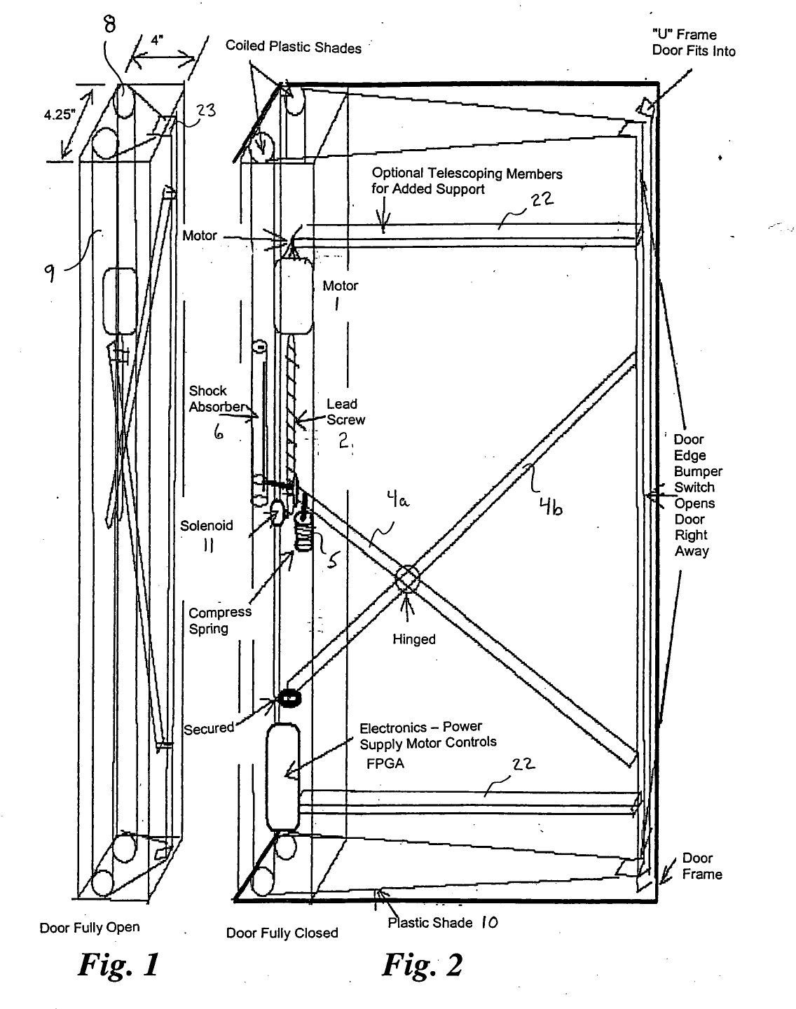

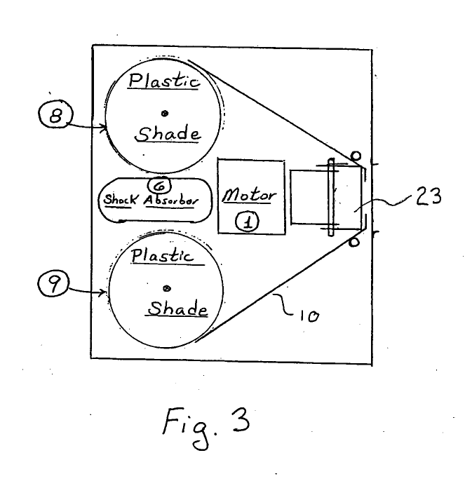

FIGS. 1 and 2 are perspective views illustrating the general features and principle of operation of a sliding replacement door in accordance with the present invention. FIG. 1 depicts the replacement door in the open, retracted state. The replacement door is designed to fit within a conventional door frame for an interior residential door. Thus, it has a depth of about 4.25 inches, and a height of about 80 inches. When used as a replacement for a typical swinging solid door, it can be provided with three pins (not shown) that fit into the hinges found in a conventional door frame. It is preferably also secured to the door frame by means of screws, or the like, to prevent swinging about the hinges. It can also be used as a replacement for a sliding door or a double width door, as explained in detail hereinafter.

In the retracted, open state shown in FIG. 1, the replacement door can have a width of about 4 inches. When extended to its closed state illustrated in FIG. 2, the replacement door can have a width of 32 inches, to completely fill the door opening. Thus, the movable end of the door (the right side as viewed in FIGS. 1 and 2) linearly translates about 28 inches in the horizontal direction during opening and closing operations. When the door is fully extended, the movable end can fit into a U-shaped channel mounted on the far side of the frame, to provide stability.

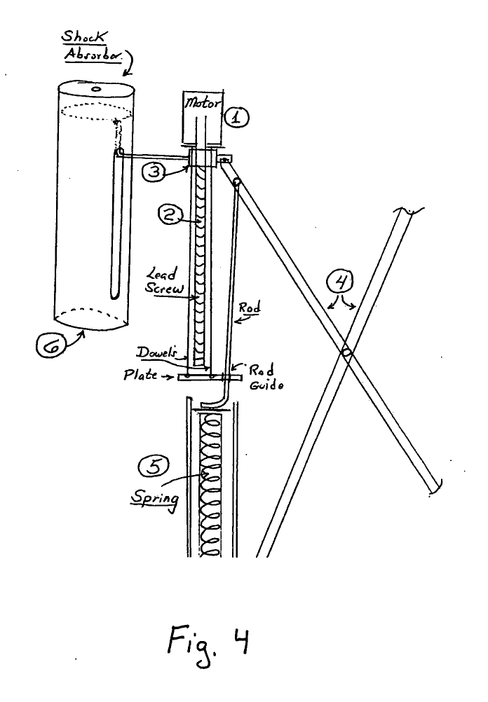

The basic components of the replacement door comprise an extendable covering and a mechanism for extending the covering into the doorway and retracting it therefrom. In one embodiment of the invention, the extendable covering comprises a pair of plastic or vinyl sheets on respective spring-biased rollers, analogous to a window shade. Referring to FIGS. 1, 2 and 3, the rollers 8 and 9 are vertically oriented and fixedly mounted at one end of the doorway, with the sheets 10 wrapped therearound. The free ends of the sheets are attached to a movable, vertically oriented rod or bar 23. The rollers 8 and 9 are spring-biased to cause the sheets to normally be wrapped around them, and thereby pull the bar 23 towards them, to the position illustrated in FIGS. 1 and 3. If desired, a sound-absorbing lining, e.g. a sponge-like material, can be provided on the interior surface of the sheets in one embodiment of the invention, to provide soundproofing. In another embodiment, the sheets can be translucent and silk-screened with a decorative scene, that is illuminated from within the interior of the sheets.

The extension mechanism can be any suitable arrangement for causing the bar 23 to move horizontally in a direction away from the rollers 8 and 9, to thereby unroll the sheets 10 from the rollers 8 and 9 against the spring bias, and extend them into the door opening, as depicted in FIG. 2. In accordance with one embodiment of the invention, the extension mechanism can be a motor-operated scissors mechanism. Referring to FIG. 2 in particular, the scissors mechanism comprises a pair of crossed arms 4 that are pivotally connected at their point of intersection. The lower end of one arm 4a is pivotally connected at a fixed point to the bar 23, and the lower end of the other arm 4b is pivotally connected to a fixed point at the door frame. The upper end of the arm 4b is connected to the bar 23 in a sliding manner, so that it can move vertically along the bar. The upper end of the arm 4a is connected to a follower 3 to be translated in a vertical direction by a motor and lead screw arrangement. When the follower 3 is at the upper end of its path of travel, away from the stationary mounting point of the arm 4b, the scissors mechanism is in an retracted position, to open the door as depicted in FIG. 1. As the motor and lead screw arrangement moves the follower 3 downwardly, so that the upper end of the arm 4a approaches the lower end of the arm 4b, the other ends of the two arms extend horizontally, to push the bar into the closed position of FIG. 2, and unroll the sheets 10 from the rollers 8 and 9.

The pivot point of the two arms 4a and 4b of the scissors mechanism can be located off-center, to gain a multiplying effect, so that the downward length of travel of the arm 4a can be less than the horizontal distance that the moving end of the door traverses. For instance, the pivot point might be located closer to the left side, as viewed in FIG. 2, such that left end of the arm 4a only needs to move 12 inches in a downward direction to cause the right ends of the arms to move horizontally a distance of 28 inches.

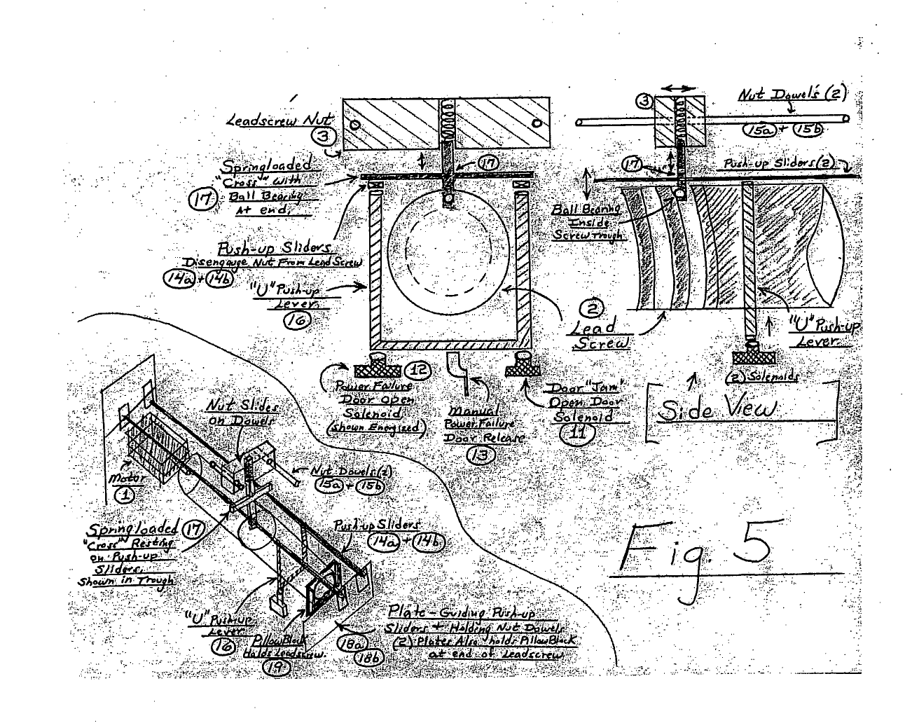

A more detailed view of the extension mechanism is shown in FIG. 4. An electric motor 1 rotates a lead screw 2. The lead screw is generally vertically oriented, and the follower 3 engages the lead screw, so as to be translated in the vertical direction when the lead screw rotates around a vertical axis. The lead screw is constrained against horizontal movement by a pair of dowels or the like. The upper end of the arm 4a is connected to the follower 3, so that vertical movement of the follower imparts corresponding movement to the arm.

In one embodiment of the invention, the motor 1 has unidirectional operation, so that the lead screw 2 always turns in the same direction, namely to cause the follower 3 to translate downwardly and thereby force the door into its extended, closed position. To return the follower to its uppermost position, and thereby open the door, a spring 5 is attached to the end of the arm 4a. In the example shown in FIG. 4, the spring 5 is a compression spring. As the follower 3 and end of the arm 4a move downwardly under the force of the motor 1 and lead screw 2, the spring 5 is compressed, via movement of an intermediate rod. When this force is released, the spring 5 returns the follower 3 and arm 4a to their uppermost positions, to retract the door.

Depending upon its strength, the force imparted by the spring 5 can cause the door to open quite rapidly, which could present an unsafe situation and/or cause damage to some of the components of the door over time. To decrease this possibility, a damping mechanism is attached to the follower 3 and arm 4a, to slow the rate of return to the retracted position of the door under the force of the spring. This damping mechanism comprises a shock absorber 6 having an closed stationary cylinder and an internal disk that moves within the cylinder. The disk is connected to the follower 3 and moves therewith. A slit is provided in the side of the cylinder to accommodate a link that connects the follower 3 to the disk. The area of this slit relative to the volume of the cylinder is relatively small, to permit only a small amount of air to escape from the cylinder while the disk is moving within it, and thereby retard the rate of movement of the disk.

As noted above, to permit the door to return to its retracted, closed position, the force of the motor 1 and lead screw 2 must be removed from the follower. In one embodiment of the invention, this might be accomplished by simply interrupting the power to the motor and permitting the lead screw to freely rotate in the reverse direction under the force of the spring 5, for instance via a clutch mechanism. In another embodiment, this can be achieved by disengaging the follower 3 from the lead screw 2. This embodiment is depicted in FIG. 5. Referring thereto, when the follower is to be translated downwardly, to close the door, the motor 1 is energized to rotate the lead screw 2. To ensure cooperative engagement of the follower with the lead screw, the follower rides on a pair of dowels 15 and includes a spring-loaded ball bearing mechanism 17 that protrudes from the surface of the follower that faces the lead screw. This ball bearing is biased to engage a spiral groove in the peripheral surface of the lead screw shaft. As the lead screw rotates, the ball bearing becomes lodged within the groove, and causes the follower 3 to translate downwardly.

When the door is to be opened, a solenoid 11 is energized, to push a U-shaped lever that engages a pair of sliders 13 on which a cross-piece of the ball bearing mechanism rides. This motion pushes the ball bearing out of engagement with the lead screw 2. Since the force imparted by the motor is no longer being transferred to the follower 3, it is free to return to the uppermost position, under the force of the spring 5.

When the door is fully closed, it is not desirable to maintain the power to the motor 1 to keep it in the closed position. To this end, therefore, the spiral groove in the lead screw terminates in a circular groove at the distal end of the lead screw. The ball bearing enters this circular groove as it reaches the fully closed state, so that further rotation of the lead screw will not result in additional downward movement of the follower 3. At this point, the motor can be de-energized.

In this configuration, the door will remain closed if a power outage occurs. The U-shaped lever can be manually pivoted by means of a lever, to move the ball bearing of the follower 3 out of engagement with the lead screw, and thereby permit the door to open. Preferably, this lever can be actuated from either side of the door, for example by means of buttons. Alternatively, if it is desirable to have the door automatically open in the event of a power outage, another solenoid 12 can be normally biased against the U-shaped lever 16 to push ball bearing out of engagement with the lead screw. As long as power is applied to this solenoid, it is in a retracted state, out of contact with the U-shaped lever. When the power fails, the solenoid releases a pin that pushes against the U-shaped lever, to cause the door to open.

To complement the arms of the scissors mechanism, added stability can be provided to the door structure in its extended, fully closed position by a pair of telescoping cross beams 22 at the top and bottom of the door structure. Referring to FIG. 2, these cross beams can comprise a set of nested tubes that are rectangular in cross section and fit one inside the other, to permit them to collapse into a compact structure of about 4 inches in length when the door is in its retracted state, and to extend to the full 32 inch width of the door frame when the door is closed. As an alternative to nested tubes, the cross beams can be formed by overlapping plates that are interlocked with one another in a manner that permits them to slide lengthwise relative to one another, in a telescoping manner. In this case, the plates that form the cross beams can be located at the very top and bottom of the sheets 10, to thereby close off the space that is formed between the sheets when the door is closed.

A sensor (not shown) can be located on the moving end of the door to interrupt the outward extension of the door if it encounters an obstruction. For instance, a rubber or plastic strip can be mounted on the bar 23 to form the leading edge of the door, in a manner that permits it to move relative to the bar under force, similar to the arrangement found on the edges of elevator doors. When this strip encounters a force as a result of an immovable obstruction, it can actuate a sensor on the bar 23. Upon receipt of a signal from this sensor, a logic controller such as an FPGA can disable the solenoid 11 to disengage the lead screw 2 from the follower 3, and thereby permit the door to retract to its open position, under the force of the spring 5. Another sensor (not shown) can be located adjacent the lower end of the path of travel of the follower 3, so that as the door approaches its fully closed position, the signal from the first sensor is disabled, so as not to cause the door to open as the strip engages the far side of the door frame.

The controller can receive any suitable type of input signal to initiate the opening and closing of the door. For example, a button can be located on each side of the door frame to send a signal to activate the motor to close the door. These same buttons might be used to open the door by toggling the logic controller to energize the solenoid 11. Alternatively, or in addition, a motion sensor can be positioned to detect movement close to one or both sides of the door, and send a signal to the controller to open the door when a person approaches with both hands occupied carrying a load. Similarly, a voice-activated sensor can be employed to generate an input signal to the controller to open the door. This sensor might also be employed to stop the door in a partially open state. For instance, by detecting the command “Stop”, the sensor can command the controller to turn off the motor. As long as the solenoid 11 is not energized, the ball bearing mechanism 17 will remain engaged with the groove in the lead screw, and thereby maintain the door in it partially open position. As an alternative to voice activation, a button can be employed to stop the door at any position during its closing movement.

In the embodiment illustrated in FIGS. 1 and 2, the sliding replacement door is employed to close a standard single-door opening that might typically be on the order of about 32 inches wide. Wider openings can be closed by using two sliding replacement doors that are respectively mounted on the two sides of the door frame and extend in opposite directions towards each other. In this case, there is no U-shaped channel for the free end of each door to fit into in the closed state. To provide stability, therefore, tracks can be provided at the top and/or bottom of the door opening to guide the bars 23 as they travel towards one another, to retain the free ends of the opposed doors in alignment with each other.

Depending upon the particular setting, the doors can be designed to provide various effects. For instance, the sheets can be made of a translucent material and lights can be disposed within the space defined by the sheets 10. When the door reaches its fully closed state, the lights can be activated to provide a brightening effect. Furthermore, a scene can be silk screened or printed on the sheets, to provide a decorative effect when the lights are activated to illuminate the scene from the inside. In another application, the sheets can be made from a light-blocking material to provide a darkening effect. When used as a closure for a cabinet, the sheets can be transparent, to permit the contents of the cabinet to be seen before the door is opened.

Variations of the concepts described above can be employed within the scope of the invention. For instance, while a scissors mechanism consisting of two pivotally connected arms has been illustrated, for converting vertical translation into horizontal extension, an extensible mechanism comprising multiple diagonally-oriented arms that are pivotally connected to one another can be employed for the same purpose. In another variation, rather than using a unidirectional motor to extend the door and a spring to return it to the retracted state, a bi-directional motor can be employed to both close and open the door.

1. A retractable door, comprising:
a pair of rollers that are spring-biased to rotate in a respective predetermined direction, said rollers being disposed parallel to each other for mounting at one edge of a door frame;
a movable rod disposed parallel to said rollers;
a pair of sheets each having one end attached to a respective one of said rollers, such that rotation of each roller in its predetermined direction causes the attached sheet to be wound about the roller, and an opposite end attached to said movable rod; and
a mechanism for moving said rod in a direction away from said rollers to cause said sheets to be unwound from said rollers and extend into a door opening.

2. The retractable door of claim 1, wherein said moving mechanism comprises an element that is translated in a direction parallel to said rollers, and a scissors mechanism that converts the translation of said element in a transverse direction to move said rod.

3. The retractable door of claim 2 wherein said moving mechanism further includes a motor and lead screw that engages said element, for translating said element in said parallel direction.

4. The retractable door of claim 3 wherein said motor and lead screw translate said element in one direction to extend said sheets into said door opening, and further including a spring to translate said element in the opposite direction to retract said sheets from said door opening.

5. The retractable door of claim 4 further including means for disengaging said element from said lead screw when said sheets are to be retracted from said opening.

6. The retractable door of claim 5, wherein said disengaging means comprises a solenoid for selectively moving said element out of engagement with said lead screw.

7. The retractable door of claim 6, wherein said element comprises a follower having a spring-biased ball bearing that engages a spiral groove in said lead screw.

8. The retractable door of claim 4, further including a shock absorber to retard the rate of movement of said element under the force of said spring.

9. The retractable door of claim 6, further including means to manually move said element out of engagement with said lead screw to permit said sheets to return to the retracted position under the force of said spring.
